(19) United States
(12) Patent Application Publication
(10) Pub. No.: US 2011/0116469 A1
(43) Pub. Date: May 19, 2011

(54) LOCAL INTERNET PROTOCOL ACCESS/SELECTED INTERNET PROTOCOL TRAFFIC OFFLOAD PACKET ENCAPSULATION TO SUPPORT SEAMLESS MOBILITY

(75) Inventors: Hao Bi, Lake Zurich, IL (US); Howard Benn, Wiltshire (GB); Scott Droste, Crystal Lake, IL (US); Jian Wu, Berkshire (GB)

(73) Assignee: Motorola, Inc., Schaumburg, IL (US)

(21) Appl. No.: 12/619,159

(22) Filed: Nov. 16, 2009

(51) Int. Cl. H04W 36/00; H04W 4/00

(52) U.S. Cl. 370/331; 370/328

(57) ABSTRACT

A method, a mobile system, and a mobility management entity are disclosed. A transceiver 302 may receive a mobility message element 750 from a mobility management entity 502. A processor 304 may use the mobility message element 750 and the transceiver 302 to establish a home data packet bearer 604 with a core packet data network gateway 506 having a data tunnel 606 to a local packet data network gateway 510 of the home network 108. A data storage 308 may associate the home data packet bearer 604 with the home network 108.

### 1. FIELD OF THE INVENTION

The present invention relates to a method and system for handing off from a home network. The present invention further relates to seamlessly transitioning from local internet protocol access to a mobile network.

### 2. INTRODUCTION

A mobile system may access a universal terrestrial radio access network (UTRAN) and an evolved UTRAN (E-UTRAN) cellular network through base stations installed at domestic homes or belonging to business and commercial enterprises, called Home NodeB (HNB) in UTRAN and Home eNodeB (HeNB) in E-UTRAN. The HNB or the HeNB may be part of an at least partially wireless local area network (LAN) referred to as a home network. The HNB or HeNB may provide access to both a core mobile network and the home network.

### SUMMARY OF THE INVENTION

A method, a mobile system, and a mobility management entity are disclosed. A transceiver may receive a mobility message element from a mobility management entity. A processor may use the mobility message element and the transceiver to establish a home data packet bearer with a core packet data network gateway having a data tunnel to a local packet data network gateway of the home network. A data storage may associate the home data packet bearer with the home network.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a communication system.

FIG. 2 illustrates a possible configuration of a computing system to act as a base transceiver station.

FIG. 3 illustrates, in a block diagram, one embodiment of a mobile system or electronic device to create a radio connection.

FIG. 4 illustrates, in a block diagram, one embodiment of a home network.

FIG. 5 illustrates, in a block diagram, one embodiment of the network architecture for connecting a mobile system to a home network via a home network base station.

FIG. 6 illustrates, in a block diagram, one embodiment of the network architecture for connecting a mobile system to a home network via a core network base station.

FIG. 7 illustrates, in a block diagram, one embodiment of an appended mobility management entity message.

FIG. 8 illustrates, in a flowchart, one embodiment of a method for managing seamless mobility with a mobility management entity.

FIG. 9 illustrates, in a flowchart, one embodiment of a method for establishing a home data packet bearer with a mobile system.

FIG. 10 illustrates, in a block diagram, one embodiment of an appended mobile system message.

FIG. 11 illustrates, in a flowchart, one embodiment of a method for transmitting data with a mobile system.

FIG. 12 illustrates, in a flowchart, one embodiment of a method for receiving data with a mobile system.

FIG. 13 illustrates, in a flowchart, one embodiment of a method for transmitting home network messages with a core packet data network gateway.

FIG. 14 illustrates, in a flowchart, one embodiment of a method for receiving home network messages with a core packet data network gateway.

FIG. 15 illustrates, in a flow diagram, one embodiment of maintaining seamless mobility.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, a mobile system, and a mobility management entity, and other embodiments that relate to the basic concepts of the invention. The mobile system may be any manner of computer, mobile device, or wireless communication device.

A method, a mobile system, and a mobility management entity are disclosed. A transceiver may receive a mobility message element from a mobility management entity. A processor may use the mobility message element and the transceiver to establish a home data packet bearer with a core packet data network gateway having a data tunnel to a local packet data network gateway of the home network. A data storage may associate the home data packet bearer with the home network.

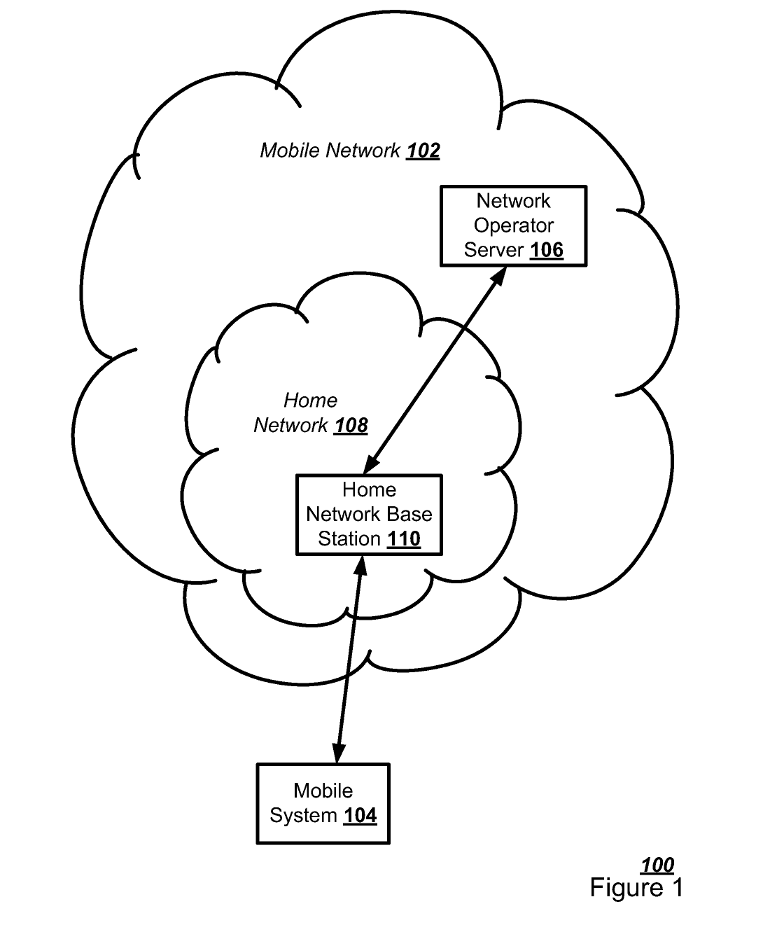

FIG. 1 illustrates one embodiment of a communication system 100. The communication system 100 may include a core mobile network 102 that may be accessed by at least one mobile device 104, such as an electronic device, mobile system, or user equipment (UE). Various communication devices may exchange data or information through the core mobile network 102. The core mobile network 102 may be a WiMAX network, a universal terrestrial radio access network (UTRAN) cellular network, an evolved UTRAN (E-UTRAN) cellular network, or other type of telecommunication network. A server or a series of servers controlled by a network operator, referred to herein as a network operator server 106, may administer the network. The network operator server 106 may maintain a set of data to facilitate access of the core mobile network 102 by the mobile system 104.

A home, office, or other localized setting may maintain a home network 108. The home network 108 may be an at least partially wireless local area network (LAN) connected to the core mobile network 102. The home network 108 may be connected to the core mobile network 102 via one or more home network base stations 110, such as a home NodeB (HNB) or a home evolved NodeB (HeNB). The mobile system 104 may use the home network base station 110 to access either the mobile network 102 or the home network 108 through the home network base station 110. The home network base station 110 may allow a mobile system 104 access, if the mobile system 104 is a part of a closed subscriber group (CSG) associated with the home network 108. The mobile system 104 may store a list of CSG identifiers (ID), or a CSG ID list, detailing which kinds of home network base station 110 the mobile system 104 may access. The network operator server 106 may store the CSG ID list to administer access to the various home networks.

If the home network base station 110 is a closed mode base station, a mobile system 104 may connect with the home network base station 110 if the mobile system 104 is a member of the associated CSG. If the home network base station 110 is a hybrid base station or open base station, a mobile system 104 may use the home network base station 110 to connect with the mobile network 102 even if the mobile system 104 is not a member of the associated CSG.

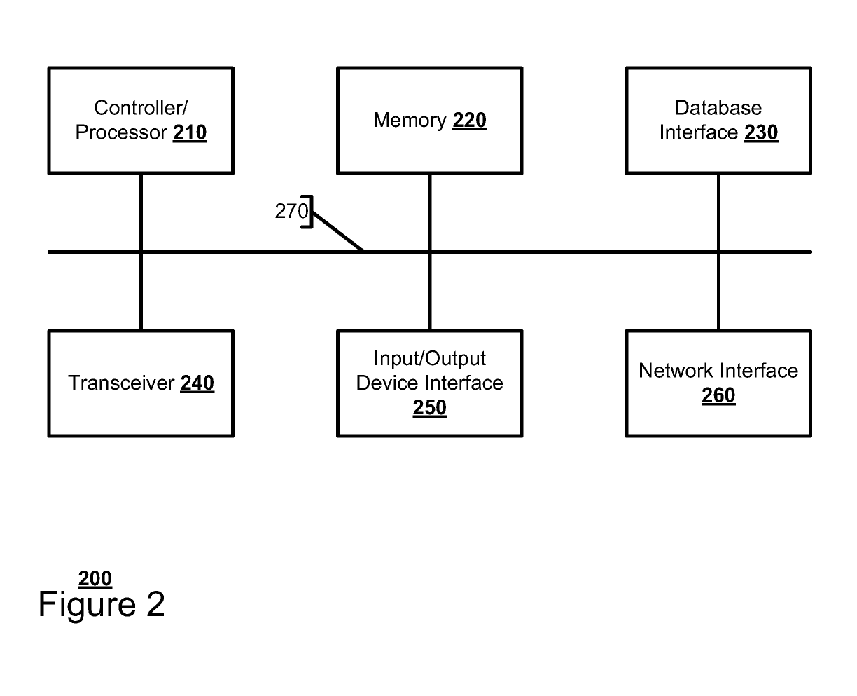

FIG. 2 illustrates a possible configuration of a computing system 200 to act as a network operator server 106 or a home network base station 110. The computing system 200 may include a controller/processor 210, a memory 220, a database interface 230, a transceiver 240, input/output (I/O) device interface 250, and a network interface 260, connected through bus 270. The network server 200 may implement any operating system. Client and server software may be written in any programming language, such as C, C++, Java or Visual Basic, for example. The server software may run on an application framework, such as, for example, a Java® server or .NET® framework

The controller/processor 210 may be any programmed processor known to one of skill in the art. However, the disclosed method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the disclosed method as described herein may be used to implement the disclosed system functions of this invention.

The memory 220 may include volatile and nonvolatile data storage, including one or more electrical, magnetic or optical memories such as a random access memory (RAM), cache, hard drive, or other memory device. The memory may have a cache to speed access to specific data. The memory 220 may also be connected to a compact disc-read only memory (CD-ROM), digital video disc-read only memory (DVD-ROM), DVD read write input, tape drive, or other removable memory device that allows media content to be directly uploaded into the system.

Data may be stored in the memory or in a separate database. The database interface 230 may be used by the controller/processor 210 to access the database. The database may contain a subscriber information set for each mobile system that may access the mobile network 102 or a home network 108.

The transceiver 240 may create a connection with the mobile device 104. The transceiver 240 may be incorporated into a base station 200 or may be a separate device.

The I/O device interface 250 may be connected to one or more input devices that may include a keyboard, mouse, pen-operated touch screen or monitor, voice-recognition device, or any other device that accepts input. The I/O device interface 250 may also be connected to one or more output devices, such as a monitor, printer, disk drive, speakers, or any other device provided to output data. The I/O device interface 250 may receive a data task or connection criteria from a network administrator.

The network connection interface 260 may be connected to a communication device, modem, network interface card, a transceiver, or any other device capable of transmitting and receiving signals from the network. The network connection interface 260 may be used to connect a client device to a network. The network interface 260 may connect the home network base station 110 to a mobility management entity of the network operator server 106. The components of the network server 200 may be connected via an electrical bus 270, for example, or linked wirelessly.

Client software and databases may be accessed by the controller/processor 210 from memory 220, and may include, for example, database applications, word processing applications, as well as components that embody the disclosed functionality of the present invention. The network server 200 may implement any operating system. Client and server software may be written in any programming language. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

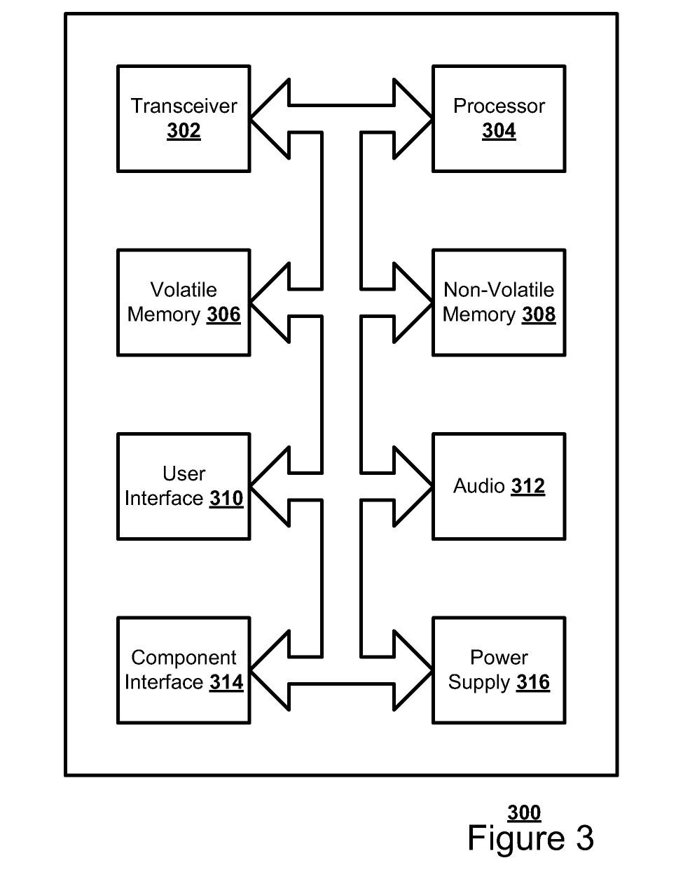

FIG. 3 illustrates one embodiment of a mobile device 300, capable of acting as a mobile system or electronic device. For some embodiments of the present invention, the mobile device 300 may also support one or more applications for performing various communications with a network. The mobile device 300 may be a handheld device, such as, a mobile phone, a laptop, or a personal digital assistant (PDA). For some embodiments of the present invention, the user device 300 may be WiFi® capable device, which may be used to access the network mobile for data or by voice using VOIP.

The mobile device 300 may include a transceiver 302, which is capable of sending and receiving data over the mobile network 102. The mobile device 300 may include a processor 304 that executes stored programs. The mobile device 300 may also include a volatile memory 306 and a non-volatile memory 308 to act as data storage for the processor 304. The mobile device 300 may include a user input interface 310 that may comprise elements such as a keypad, display, touch screen, and the like. The mobile device 300 may also include a user output device that may comprise a display screen and an audio interface 312 that may comprise elements such as a microphone, earphone, and speaker. The mobile device 300 also may include a component interface 314 to which additional elements may be attached, for example, a universal serial bus (USB) interface. Finally, the mobile device 300 may include a power supply 316.

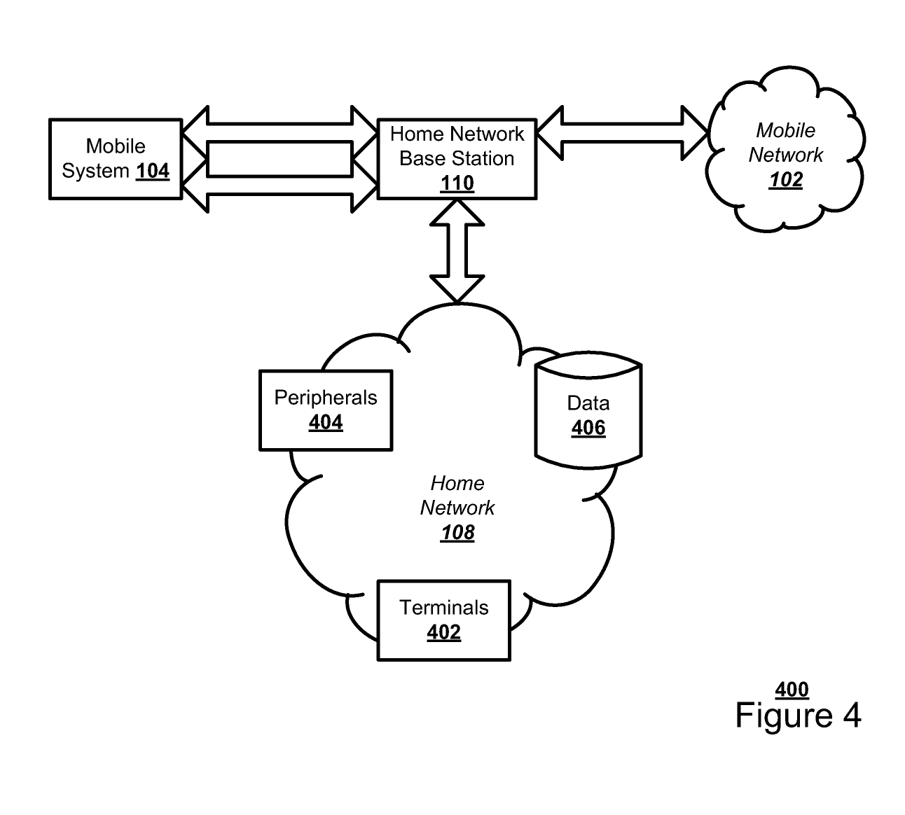

FIG. 4 illustrates, in a block diagram, one embodiment of a home network interaction 400. A mobile system 104 may access a mobile network 102, or core mobile network 102, via the home network base station 110, such as if the home network base station 110 is on the CSG ID list for the mobile system 104. Additionally, the home network 108 is attached to the home network base station 110. The mobile system 104 may access the home network 108. Local internet protocol access may provide a directly connected, IP capable mobile system 104 access to other IP capable devices in the home network 108 and to the internet through the home network 108. A home network owner may have control over access to the home network 108. The home network base station 110 may provide varying degrees of access to a portion of the home network 108 based on the mobile trust level provided by the network operator server 106. For example, the home network owner may allow a guest user to use the home network 108 to access the core mobile network 102 for voice, media, or other data sets.

For example, a mobile system 104 with a low mobile trust level may be limited to sending and receiving communications to user terminals 402 on the home network 108 or limited to contact with the mobile network 102. A mobile system 104 with an intermediate mobile trust level may user peripheral devices 404 connected to the home network 108, such as printers, audio players, video displays, and other peripheral devices. A mobile system 104 with a high mobile trust level may access data 406 stored in the home network 108.

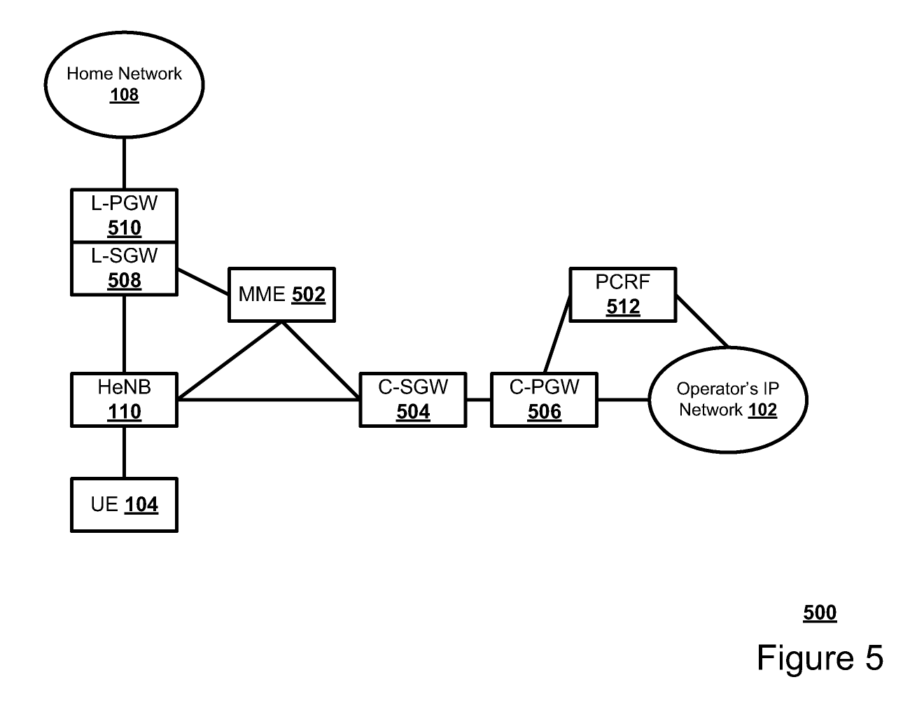

FIG. 5 illustrates, in a block diagram, one embodiment of the network architecture 500 connecting a mobile system 104 to a home network 108 via a home network base station 110. A mobility management entity (MME) 502 may use the home network base station, or home evolved node B (HeNB), 110 to control the interaction between the mobile system 104, or user equipment (UE), and the home based internet protocol (IP) network 108 or the mobile operator's core IP network 102. A core serving gateway (C-SGW) 504 may route user data packets. A core packet data network (PDN) gateway (C-PGW) 506 may connect the UE 104 to an external PDN. The HeNB 110 may perform local IP access support function by using a local serving gateway (L-SGW) 508 and a local PDN gateway (L-PGW) 510. The L-SGW 508 may provide an evolved packet system (EPS) connection management (ECM) idle mode for downlink packet buffering and an initiation of a network triggered service request procedure. The L-SGW 508 may collect uplink and downlink traffic statistics. The L-PGW 510 may allocate the UE IP address to access the home based IP network 108. The L-PGW 510 may provide dynamic host configuration protocol functions. A policy and charging rules function (PCRF) module 512 may provide network control regarding the service data flow detection, gating, quality of service (QoS), and flow based charging.

When a mobile system 104 connects to the home network base station 110, the MME 502 may decide that traffic of certain applications are to be routed through the L-SGW 510 and L-PGW 508 to the home network 108 using the local breakout support function. The traffic may terminate at the devices on the home network, such as a local IP access (LIPA), or may terminate at the servers on the internet or operator's IP network 102, such as selected IP traffic offload (SIPTO). When the mobile system 104 moves from the home network base station 110 to another core network base station, or evolved Node B (eNB), which is not attached to the local breakout support function associated with the home network 108, the MME 502 may switch routing the traffic of the mobile system 104 through the operator's core network.

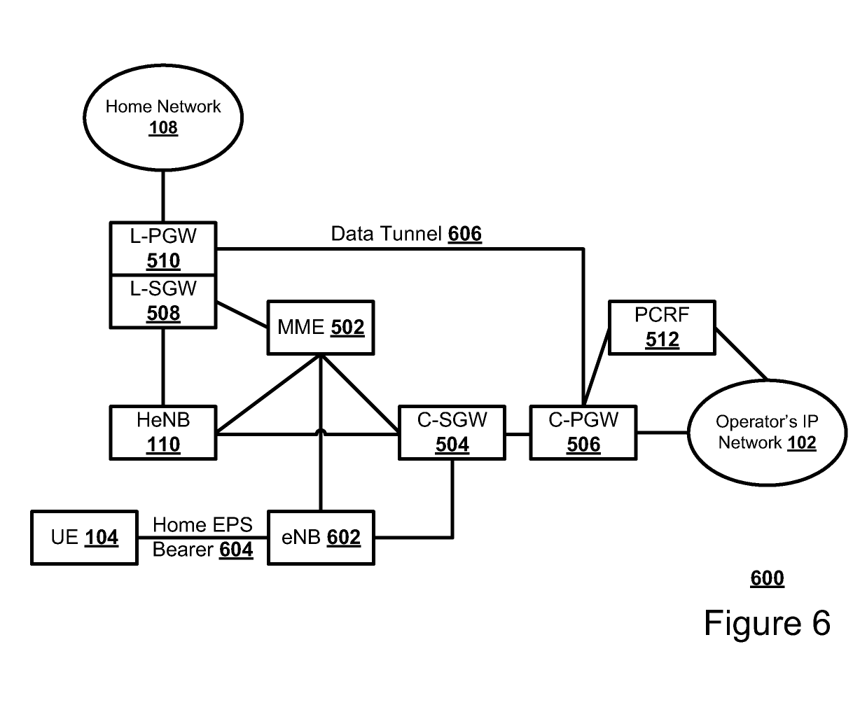

In order to maintain service continuity for LIPA/SIPTO applications, the C-PGW 506 may establish a data tunnel with the L-PGW 510 in the local breakout support function to route LIPA/SIPTO traffic between the home network 108 and the mobile system 104. FIG. 6 illustrates, in a block diagram, one embodiment of the network architecture 600 connecting a mobile system 104 to a home network 108 via a core network base station 602. The mobile system 104 may establish a home data packet bearer 604, such as an EPS bearer 604, with the C-PGW 506 for the specific purpose of LIPA/SIPTO traffic between the mobile system 104 and the home network 108. The mobile system 104 and the C-PGW 506 may associate the home EPS bearer 604 with the home network 108, or more specifically, with data traffic originating or terminating with the home network 108. The C-PGW 506 may establish a data tunnel 606 with the L-PGW 510 to transfer LIPA/SIPTO traffic between the C-PGW 506 and the L-PGW 510.

The mobile system 104 may send data traffic for the home network 108 to the C-PGW 506 via the specific EPS bearer 604. The C-PGW 506 may send data traffic received on the specific EPS bearer 604 to the L-PGW 510 via the data tunnel 606. Conversely, the C-PGW 506 may receive data traffic from the home network 108 via the data tunnel 606. The C-PGW 506 may send the received home network data traffic to the mobile system 104 via the specific EPS bearer 604. The mobile system 104 may identify any data traffic received via the specific EPS bearer 604 as originating from the home network 108.

The MME 502 may send a non-access stratum (NAS) mobility message element to the mobile system 104 when the tunneling may be used for LIPA/SIPTO traffic between the L-PGW 510 in the local breakout support function and the C-PGW 506. The MME 502 may send a mobility message element upon detection of a mobility event. The mobility event may be the imminent termination of the connection to the local breakout support function, such as when the mobile system 104 moves from a home network base station 110 to handover to a core network base station 602 not attached to the home network 108. The mobility message element may inform the mobile system 104 how to retrieve LIPA/SIPTO packets from the traffic received on EPS bearers 604 from the C-PGW 506 and how to insert the LIPA/SIPTO packets to the traffic sent on EPS bearers 604 to the C-PGW 506. The mobility message element may be sent in a new message or appended to other messages, such as an “Activate Default EPS Bearer Context Request”, “Activate Dedicated EPS Bearer Context Request”, “Modify EPS Bearer Context Request”, “Bearer Resource Modification Reject”, or “Deactivate EPS Bearer Context Request”.

Among other data, the mobility message element may include an EPS bearer ID, the access point name (APN) identifying the home network 108, and the traffic flow template (TFT) for the IP traffic to be directed through the home network 108.

The EPS bearers, which may be established towards the operator's core network 102, may be maintained when a mobile system 104 is handed over from a home network base station 110 to another cell. In order to maintain service continuity of IP applications, IP traffic may be put on the EPS bearers established towards the operator's core network 102. A mobile system 104 may use an APN of the mobility message element to determine which PDN's or home network's traffic is to be associated with the identified bearer. Once the new PDN connectivity is established, mobile system 104 may put the IP traffic, which used to be routed using local IP access through the identified home network 108, on the EPS bearers established towards the operator's core network 102. This way, service continuity may be maintained even when the local IP access to the home based network 108 is disabled.

The MME 502 may also indicate the type of IP traffic for which service continuity may be maintained by sending the related TFT in the mobility message element. A TFT may include a set of packet filters defining the IP traffic to be carried on the associated bearer. The packet filter may define a variety of rules, such as specifying IP traffic destined to particular sites or of particular applications to be carried on the associated bearer. For example, the TFT may define a remote address type, a protocol identifier or next header type, a single local port type, a local port range type, a single remote port type, a remote port range type, a security parameter index type, a type of service or traffic class type, a flow label type, or other rules.

Using APN and TFT, the network may pick the IP services, as indicated by the TFT, to support service continuity and tailor the available resources on the operator's core network to support the selected IP traffic to and from the targeted home network 108, as indicated by the APN.

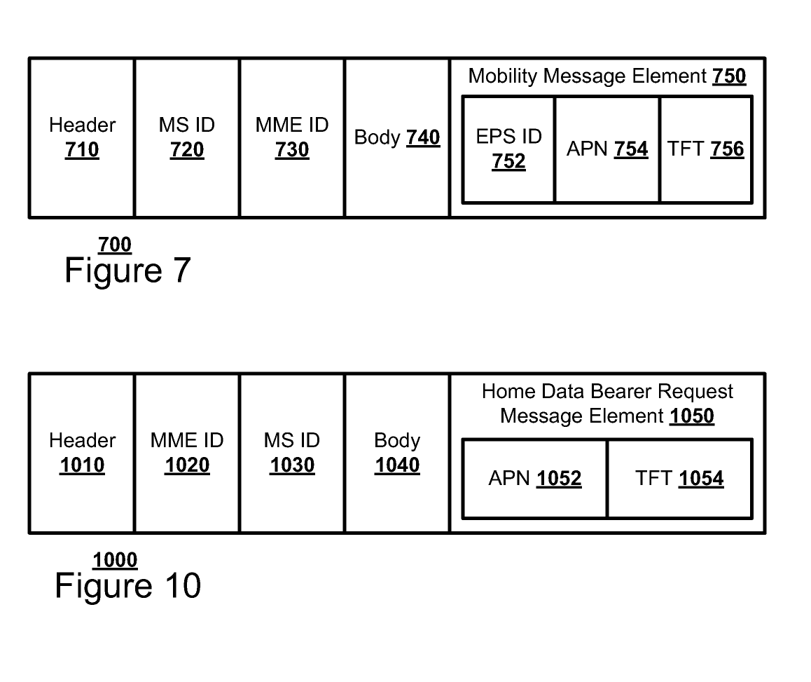

The MME 502 may independently send a mobility message element, or append it to a MME message being sent to the mobile system 104. FIG. 7 illustrates, in a block diagram, one embodiment of an appended MME message 700. The appended MME message 700 may have a header 710 to indicate the route and destination, a mobile system identifier (MS ID) 720, a MME ID 730, and a body 740 containing message data. Additionally, the appended MME message 700 may have a mobility message element 750. The mobility message element 750 may have an EPS bearer ID field 752 identifying the home data packet bearer 604 to be associated with a home network traffic, an APN field 754 to indicate a PDN associated with the home network 108, and an associated TFT 756 indicating a data traffic type for the home data packet bearer to be routed through the targeted PDN.

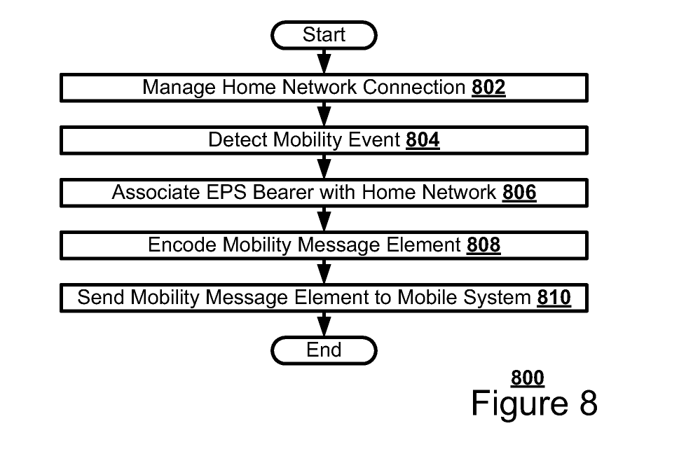

FIG. 8 illustrates, in a flowchart, one embodiment of a method 800 for managing seamless mobility with a MME 502. The MME 502 may manage a connection between a mobile system 104 and a home network 108 (Block 802). The MME 502 may detect a mobility event, such as a base handover or a home data bearer request message element from the mobile system 104 (Block 804). The MME 502 may associate the home EPS bearer 604 with the home network 108(Block 806). The MME 502 may encode the mobility message element with an EPS bearer ID 752 for the home EPS bearer 604, an APN 754 for the home network 108, and a TFT 756 indicating a data traffic type for the EPS bearer 604 (Block 810).

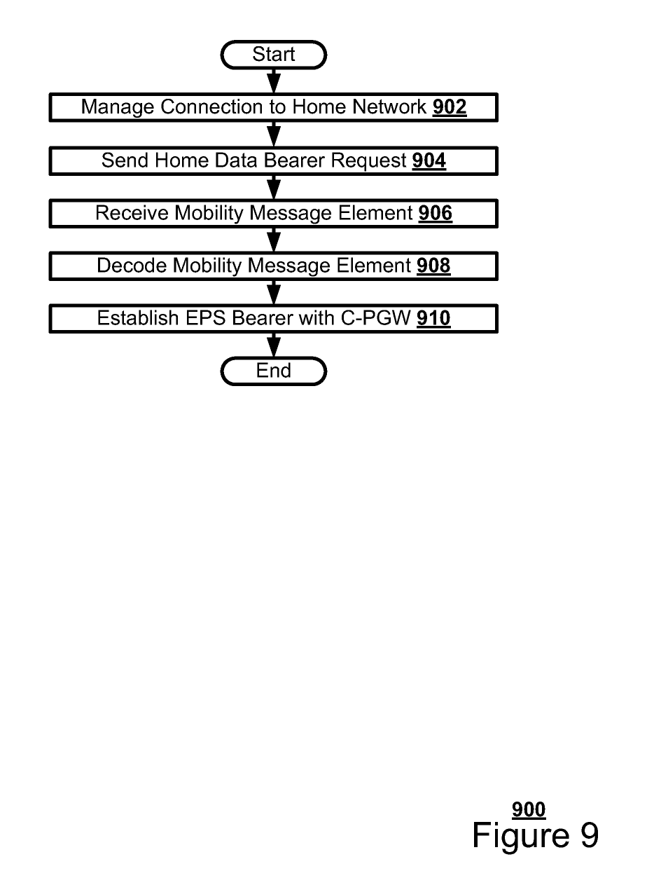

The mobile system 104 may trigger the mobility message element 750 independent of a base handover. FIG. 9 illustrates, in a flowchart, one embodiment of a method 900 for establishing a home EPS bearer 604 with a mobile system 104. The mobile system 104 may manage a connection to the home network 108 (Block 902). The mobile system 104 may send a home data bearer request message element to the MME 502 to trigger a mobility message element (Block 904). The mobile system 104 may receive the mobility message element 750 from the MME 502 (Block 906). The mobile system 104 may decode the mobility message element 750 to determine an EPS bearer ID 752, an APN 754, and a TFT 756 (Block 908). The mobile system 104 may establish the home EPS bearer 604 with the C-PGW 506 (Block 910).

The mobile system 104 may independently send the home data bearer request message element, or append it to a mobile system message sent to the MME 502. FIG. 10 illustrates, in a block diagram, one embodiment of an appended mobile system message 1000. The appended mobile system message 1000 may have a header 1010 to indicate the route and destination, a MME ID 1020, a MS ID 1030, and a body 1040 containing message data. The appended mobile system message 1000 may have a home data bearer request message element 1050. The home data bearer request message element 1050 may have an APN field 1052 to indicate a requested PDN 108, such as a home network 108, for which a bearer is requested. The home data bearer request message element 1050 may have an associated TFT 1054 indicating a data traffic type whose data packet is to be transferred on the requested EPS bearer and routed through the indicated PDN 108, such as a home network 108.

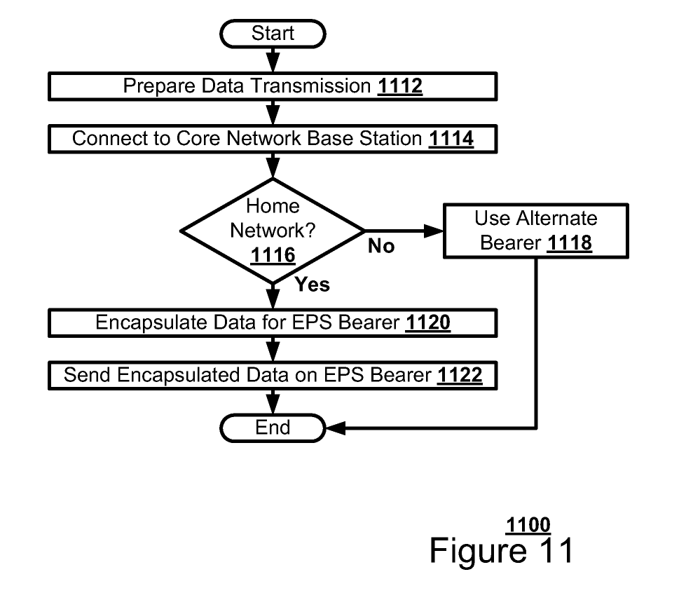

Once the home EPS bearer 604 has been established, the mobile system 104 may send and receive data traffic from the home network 108. FIG. 11 illustrates, in a flowchart, one embodiment of a method 1100 for transmitting data with a mobile system 104. The mobile system 104 may prepare a data transmission to be sent to the home network 108 via a C-PGW 506 (Block 1102). The mobile system 104 may connect to a core network base station 602 (Block 1104). If the data transmission is a regular transmission to be sent to the operator's IP network 102 (Block 1106), the mobile system 104 may send the data transmission using an alternate bearer to the home EPS bearer 604 (Block 1108). If the data transmission is a LIPA/SIPTO transmission to be sent to the home network 108 (Block 1106), the mobile system 104 may encapsulate the data transmission for the home EPS bearer 604 (Block 1110). The mobile system 104 may send the encapsulated data packet on the home EPS bearer 604 (Block 1112).

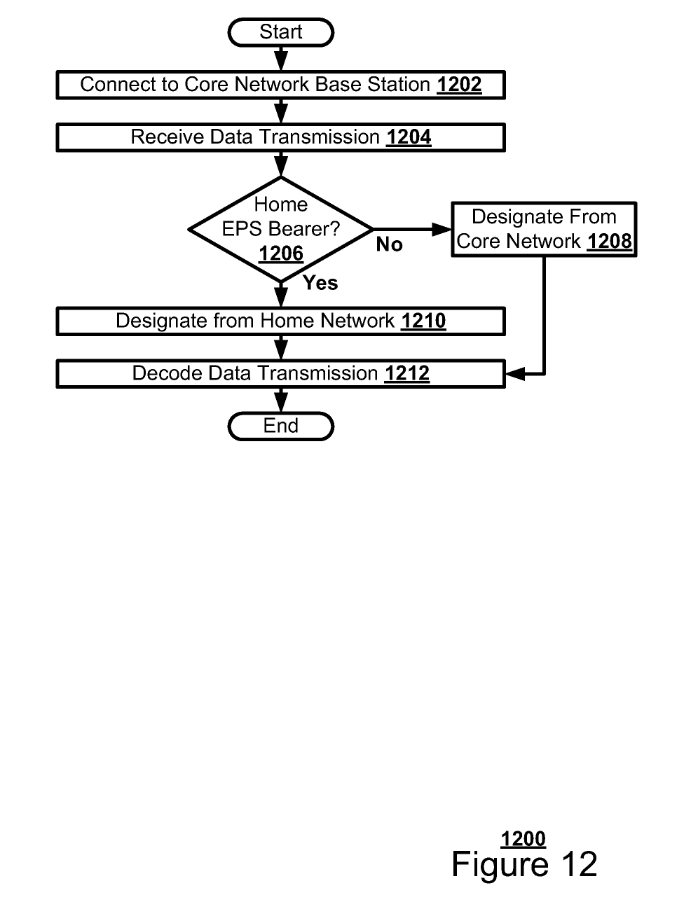

FIG. 12 illustrates, in a flowchart, one embodiment of a method 1200 for receiving data with a mobile system 104. The mobile system 104 may connect to a core network base station 602 (Block 1202). The mobile system 104 may receive a data transmission from the home network 108 via a C-PGW 506 (Block 1204). If the data transmission was received via an alternate bearer to the home EPS bearer 604 (Block 1206), the mobile system 104 may designate the data transmission as being from the operator's IP network 102 (Block 1208). If the data transmission was received via the home EPS bearer 604 (Block 1206), the mobile system 104 may designate the data transmission as being from the home network 108 (Block 1210). The mobile system 104 may then decode the encapsulated data packet (Block 1212).

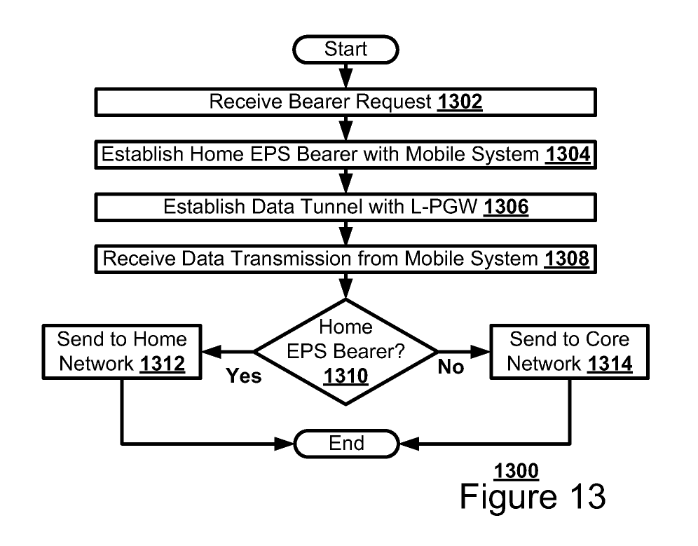

FIG. 13 illustrates, in a flowchart, one embodiment of a method 1300 for transmitting home network messages with a C-PGW 506. The C-PGW 506 may receive a data packet bearer request to establish a connection between the mobile system 104 and the home network 108 (Block 1302). The data packet bearer request may have an EPS bearer ID 752 identifying a home EPS bearer 604 and an APN 754 to identify the home network 108. The C-PGW 506 may establish a home EPS bearer 604 with the mobile system (Block 1304). The C-PGW 506 may establish a data tunnel 606 with the L-PGW 510 of the home network 108 identified by the APN 754 (Block 1306). Once the home EPS bearer 604 is established, the C-PGW 506 may receive a data transmission from the mobile system 104 (Block 1308). If the data transmission is received from the home EPS bearer 604 (Block 1310), the C-PGW 506 may send the received data transmission to the home network 108 (Block 1312). If the data transmission is received from the alternate data packet bearer (Block 1310), the C-PGW 506 may send the received data transmission to the operator's IP network 102 (Block 1314).

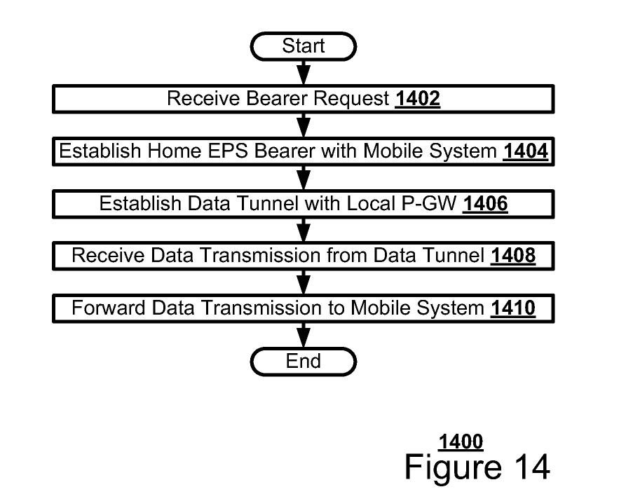

FIG. 14 illustrates, in a flowchart, one embodiment of a method 1400 for receiving home network messages with a C-PGW 506. The C-PGW 506 may receive a data packet bearer request to establish a connection between the mobile system 104 and the home network 108 (Block 1402). The data packet bearer request may have an EPS bearer ID 752 identifying an EPS bearer 604 and an APN 754 to identify the home network 108. The C-PGW 506 may establish a home EPS bearer 604 with the mobile system (Block 1404). The C-PGW 506 may establish a data tunnel 606 with the L-PGW 510 of the home network 108 identified by the APN 754 (Block 1406). The C-PGW 506 may receive a data transmission from the L-PGW 510 via the data tunnel 606 (Block 1408). Once the home EPS bearer 604 is established, the C-PGW 506 may forward the data transmission on the home EPS bearer 604 to the mobile system 104 (Block 1410).

Based on the information included in the mobility message element 750, the mobile system 104 may establish a home EPS bearer 604 towards the core network 102. The mobile system 104 may encapsulate LIPA/SIPTO packets of the identified home network 108 into the payload of the home EPS bearer 604. The mobile system 104 may generate LIPA/SIPTO packets for the applications meeting the traffic descriptions defined in the mobility message element 750, such as through TFT-like filters. These LIPA/SIPTO packets may maintain the IP context shared between the mobile system 104 and the home network 108. The MME 502 may send multiple mobility message elements 750 to a mobile system 104, so that multiple home EPS bearers 604 may be established towards possibly multiple C-PGWs 506 in the core network 102 for different applications. Since seamless mobility is supported for the EPS bearer for the core network 102 during handover, service continuity may be maintained for LIPA/SIPTO applications, as the mobile system 104 moves away from the home network 108.

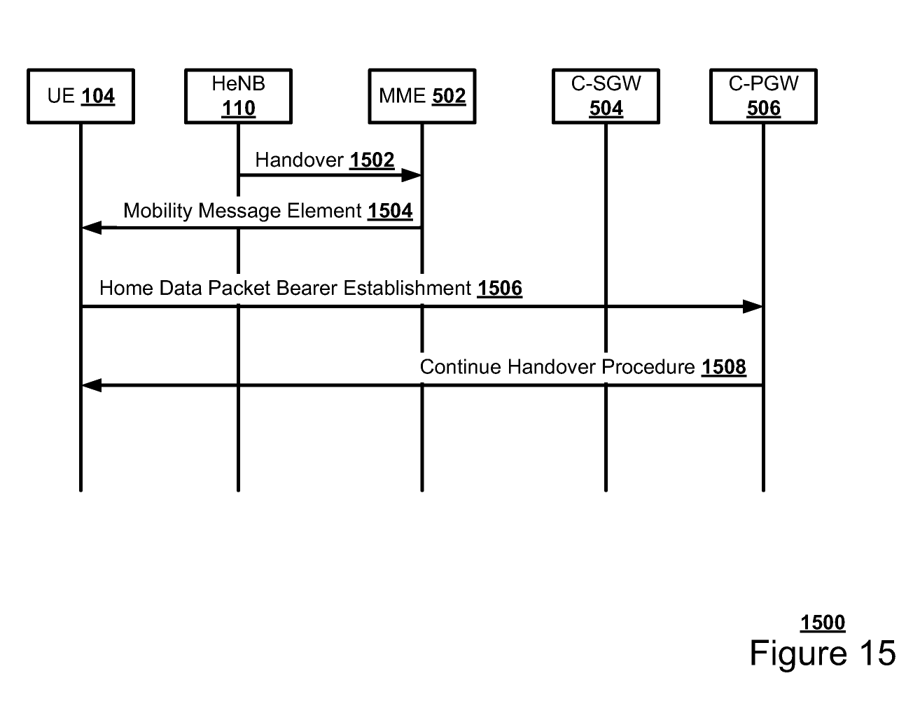

FIG. 15 illustrates, in a flow diagram, one embodiment of maintaining seamless mobility 1500. The home network base station 110 may send a notification 1502 to the MME 502 that a handover is imminent. The MME 502 may send a mobility message element 1504 to the mobile system 104. The mobile system 104 may establish a home EPS bearer associated with the EPS bearer ID 752 to C-PGW 506, which has a data tunnel 606 to the home network 108 associated with the APN 754. Then handover procedure 1508 may be carried out with the mobile system 104 involving the home network base station 110, the MME 502, the C-SGW 504, and the C-PGW 506.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for supporting seamless mobility, comprising:
receiving at a mobile system a mobility message element from a mobility management entity;
using the mobility message element to establish a home data packet bearer between the mobile system and a core packet data network gateway with a data tunnel to a local packet data network gateway of the home network; and
associating the home data packet bearer with the home network.

2. The method of claim 1, wherein the mobility message element has an evolved packet system bearer identifier indicating the home data packet bearer.

3. The method of claim 1, wherein the mobility message element has an access point name field indicating the home network.

4. The method of claim 1, wherein the mobility message element has a traffic flow template describing a data traffic type for the home data packet bearer.

5. The method of claim 1, further comprising:
sending a home data bearer request message element to the mobility management entity from the mobile system to trigger a mobility message element.

6. The method of claim 5, wherein the home data bearer request message element indicates the home network and a traffic type.

7. The method of claim 1, further comprising:
sending an encapsulated data packet on the home data packet bearer to the core packet data network gateway to be forwarded to the home network via the data tunnel.

8. The method of claim 1, further comprising:
receiving on the home data packet bearer from the core packet data network gateway an encapsulated data packet from the home network received via the data tunnel.

9. A mobile system that supports seamless mobility, comprising:
a transceiver that receives a mobility message element from a mobility management entity;
a processor that uses the mobility message element and the transceiver to establish a home data packet bearer with a core packet data network gateway having a data tunnel to a local packet data network gateway of the home network; and
a data storage that associates the home data packet bearer with the home network.

10. The mobile system of claim 9, wherein the mobility message element has an evolved packet system bearer identifier indicating the home data packet bearer.

11. The mobile system of claim 9, wherein the mobility message element has an access point name field indicating the home network.

12. The mobile system of claim 9, wherein the mobility message element has a traffic flow template describing a data traffic type for the home data packet bearer.

13. The mobile system of claim 9, wherein the transceiver sends a home data bearer request message element to the mobility management entity from the mobile system to trigger a mobility message element.

15. The mobile system of claim 9, wherein the transceiver sends an encapsulated data packet on the home data packet bearer to the core packet data network gateway to be forwarded to the home network via the data tunnel.

15. The mobile system of claim 9, wherein transceiver receives on the home data packet bearer from the core packet data network gateway an encapsulated data packet from the home network received via the data tunnel.

16. A mobile management entity that supports seamless mobility, comprising:
a processor that encodes a mobility message element with an evolved packet system bearer identifier to establish a home data packet bearer between a mobile system and a core packet data network gateway having a data tunnel to a local packet data network gateway of a home network;
a data storage that associates the home data packet bearer with the home network; and
a network interface that sends the mobility message element to the mobile system.

17. The mobile management entity of claim 16, wherein the mobility message element has an evolved packet system bearer identifier indicating the home data packet bearer.

18. The mobile management entity of claim 16, wherein the mobility message element has an access point name field indicating the home network.

19. The mobile management entity of claim 16, wherein the mobility message element has a traffic flow template describing a data traffic type for the home data packet bearer.

20. The mobile management entity of claim 16, wherein processor detects a base handover.
